(19) United States
(12) Patent Application Publication
(10) Pub. No.: US 2020/0263822 A1
(43) Pub. Date: Aug. 20, 2020

(54) SERVICE REINFORCEMENT SLEEVE AND METHOD OF USE

(71) Applicant: FER-PAL CONSTRUCTION LTD., Toronto (CA)

(72) Inventors: Kendrick Shaun MCKAIGUE, Bradford (CA); Vadim KOSSENIOUK, Richmond Hill (CA)

(73) Assignee: FER-PAL CONSTRUCTION LTD.

(21) Appl. No.: 16/277,526

(22) Filed: Feb. 15, 2019

(51) Int. Cl. F16L 55/165; B29C 63/18; B29C 63/00; B29C 73/04; F16L 55/18

(52) U.S. Cl. CPC F16L 55/1653; B29C 63/18; B29C 63/0004; B29L 2023/22; F16L 55/1656; F16L 55/18; B29C 73/04

(57) ABSTRACT

A service reinforcement sleeve is disclosed with a flange and a tubular section that can be used, with epoxy, to bind a service to a structural liner such as a cured-in-pipe structural liner. This sleeve has flexible tabs with lips (defined by cutouts) on the end of the tubular section opposite the flange. This sleeve can accommodate encrustation in the service, particularly when it is located away from the bottom of the service. A method of bonding a service and structural liner using this sleeve and epoxy is also disclosed that uses a metal brush or similar device to create a seat in the liner and abrade the lower portion of the service before insertion of the sleeve.

### FIELD OF THE INVENTION

The invention described herein generally relates to a service reinforcement sleeve and method to soundly connect services conduits that are being rehabilitated using with a structural liner that uses the service reinforcement sleeve. This method and device are useful in situations where the conduit is in danger of eroding or has eroded around the service, and the service has mineral deposits, encrustation or tuberculation on its inside walls. The service reinforcement sleeve also addresses problems with the use of tube and flange devices when connecting services in situations where the service is at or near the top of the conduit.

### BACKGROUND OF THE INVENTION

Conduits for fluids, such as water or sewage conduits, or gas or chemical pipe, deteriorate over time. For example, many of the water mains throughout North America are made from unlined cast-iron pipe, the preferred material for water distribution systems up to the mid-1970's and beyond. Over time such pipes will deteriorate, often due to corrosion, becoming pitted and forming tubercules. This corroded material, in combination with mineral deposits, is known as encrustation and tuberculation.

Such deterioration results in leakage of the fluids, such as water or sewage, into the surrounding environment. For example, in 2013, Toronto experienced approximately 1700 water main breaks. These cause drops water pressure drops, and the leaking fluids can weaken the surrounding ground and can interfere with other underground systems, such as communication systems or other water or fluid bearing conduits. Such conduits need to be rehabilitated.

One approach to rehabilitation is to replace the deteriorated conduit. However, this can be a very costly and labour-intensive exercise; for example, if the conduit is a buried water pipe, replacement involves setting up a work area and digging up the pipe, known as “open-cut replacement”.

One solution is to deploy a cured-in-place structural liner within the conduit. For example, Canadian patent no. 2,361,960 of Mercier describes the use of a cured-in-place structural liner. The liner consists of two concentric tubular jackets (an outer and an inner jacket) made of a flexible material that are impregnated with an adhesive resin. Bonded to the inner surface of the inner jacket is a film that is impermeable to liquid to flow through the conduit. The liner is inserted into one end of a dry conduit and then pulled into place. A shaping step then occurs, where the liner is made to conform to the inner wall of the conduit. The liner is then cured in place by flowing heated water through the conduit. This causes the liner to become a rigid structure, bonded to the inner surface of the conduit.

In one example, such an approach results in a conduit lined with a polyurethane and fabric liner, typically 1/16 to ¼ of an inch thick, which is sealed in place with epoxy.

When rehabilitated conduits using a cured-in-place liner system, a goal is to create a “structural liner”—a liner that has sufficient structural and functional integrity that it will function as a replacement conduit even if the original conduit totally fails.

A related issue but increasingly prominent issue is erosion, crumbling and failure of the conduit around a service attached to the conduit. The attachment between a conduit and service puts stress on the conduit immediately around the service. Similarly, after a structural liner is installed, the attachment between a conduit and service puts stress on the conduit immediately around the service. It is desirable for a seal to be formed around the conduit that will prevent or minimize leakage even if the conduit fails around the service after the installation of the structural liner. It is also desirable to have a method to seal the service in cases where the conduit around the service has already failed before the installation of the structural liner. In either case, once the liner is inserted, inflated and cured, the cured-in-place liner is supposed to last for decades in constant use without failure and minimizing leakage.

Approaches and devices to assist in sealing connections between conduits and services, including in cases where there is a cured-in-place liner used. U.S. patent application Ser. No. 12/359,646 (pub. no. 2010/0187813) of Anders discloses a connector with a tubular member and an annular flange that is used to connect a lateral pipe to a main pipe. According to the abstract, the annular flange is glued to the inner surface of the main pipe and the tubular extends through an opening formed in the main pipe. PCT application no. PCT/GB00/00990 (pub. no. WO 00/55539) of Sanders discloses several sealing devices including a device with a hollow cylindrical bore and an annular part which is dished.

### SUMMARY OF THE INVENTION

The invention in part involves a service reinforcement sleeve with a flange and a tubular section that can be used to bind a service to a liner with epoxy. This sleeve addresses the need to simultaneously be capable of remaining in the service until the epoxy cures in cases where there is no encrustation in the service, but also to be able to accommodate encrustation in the service, while attempting to minimize the distance between the sleeve and the inner walls of the service and the sleeve and the liner in order to promote a strong bond via the liner, sleeve and service via epoxy. In particular, minimizing the distance between the sleeve and the inner walls of the service and the sleeve and the liner reduces the possibility of voids in the epoxy, noting that such voids weakens the bond. The service reinforcement sleeve achieves this by employing flexible tabs (created by cutouts) at the end of the tubular section opposite the flange, where each tab has a lip.

The method of installation is designed to take advantage of the service reinforcement sleeve and increase the chances of a strong bond between the liner and service being formed. When lining a conduit, the service is typically first plugged in some manner with a plug, for example with a cork. Once the structural liner is in place and cured, the services are opened and the cork/plug removed, which leaves some cork/plug debris. The cork/plug debris is removed with a metal brush or similar device, which has at least three beneficial results: it creates a seat in the liner suitable for holding the flange of the service reinforcement sleeve; it cleans the service of encrustations at the lower end of the service which allows the service reinforcement sleeve to travel some distance up the service (during subsequent installation) before encountering encrustations; and it creates micro-abrasions in the lower end of the service which promote better bonding with epoxy. An insertion instrument is then used to insert a service reinforcement sleeve, covered with epoxy, into the service.

In accordance with the invention, there is provided a service reinforcement sleeve for bonding a service to a structural liner comprising: a tubular body having a first end and a second end opposite the first end, where the tubular body provides a conduit along which fluid may flow; a flange extending generally radially from the first end of the tubular body; at least three tabs defined by cutouts at the second end of the tubular body, where each tab has a lip extending generally radially from the end of the tab. In an aspect of this invention, the sleeve is made of stainless steel. In another aspect of this invention, the sleeve is made of a material with similar mechanical properties to stainless steel. In another aspect of this invention, the tabs are sized to enable sufficient binding to occur for the sleeve to remain in a service under the effects of gravity. In yet another aspect of this invention, the flange is an annular ring extending radially from the outer diameter of the first end. In a further aspect of this invention, the flange has a diameter of 31.3436 mm, a thickness of 0.7874 mm, the conduit formed by the tubular member has a diameter of 14.097 mm the tubular member has a length 21.1582 mm and a wall thickness of 0.762 mm, and there are four tabs defined by cutouts with a width of 5.3086 mm and a length 9.017 mm, and each lip has an extension of 0.381 mm and is located a distance 2.54 mm from the end of the tab. In a further aspect of this invention, the flange has a diameter of 31.3436 mm, a thickness of 0.7874 mm, the conduit formed by the tubular member has a diameter of 14.097 mm the tubular member has a length 21.1582 mm and a wall thickness of 0.762 mm, and there are four tabs defined by cutouts with a width of 5.3086 mm and a length 9.017 mm, and each lip has an extension of 0.381 mm and is located a distance 2.54 mm from the end of the tab, and this sleeve has an allowable deflection falls within the range of 0.221 mm to 0.381 mm. In a further aspect of this invention, the tubular body is embossed or roughened.

In accordance with this invention, there is also provided a method of bonding a service attached to a conduit to a structural liner installed in the conduit, comprising: locating the service and inserting a plug into the service; installing a structural liner; opening the service and removing the plug; using an abrading device to abrade the lower part of the service and the surrounding liner; preparing a service reinforcement sleeve which comprises: a tubular body having a first end and a second end opposite the first end, where the tubular body provides a conduit along which fluid may flow; a flange extending generally radially from the first end of the tubular body; and at least two tabs defined by cutouts at the second end of the tubular body, where each tab has a lip extending generally radially from the end of the tab; coating the tubular body and the flange with epoxy; inserting the service reinforcement sleeve into the service; and allowing the epoxy to cure. In an aspect of this invention, the plug is a cork. In another aspect of this invention, the structural liner is a cured-in-place liner. In another aspect of this invention, the step of using an abrading device to abrade the lower part of the service and the surrounding liner creates a seat in the liner around the service; and abrades a portion of the service nearest the structural liner. In yet another aspect of this invention, the step of inserting the service reinforcement sleeve into the service comprises inserting the sleeve so that the flange rests in the seat.

In accordance with this invention, there is provided a service bonded to a structural liner, comprising: a service reinforcement sleeve which comprises: a tubular body having a first end and a second end opposite the first end, where the tubular body provides a conduit along which fluid may flow; a flange extending generally radially from the first end of the tubular body; and at least two tabs defined by cutouts at the second end of the tubular body, where each tab has a lip extending generally radially from the end of the tab; the service being bonded to the tubular body; and the liner being bonded to the flange. In an aspect of this invention, the service is bonded to the tubular body by epoxy and the liner is bonded to the flange by epoxy. In another aspect of this invention, the flange is bonded to a seat that has been abraded into the liner.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is an illustration of a conduit and service.

FIG. 2 is an illustration of a conduit and service lined with a structural liner where the service has been opened.

FIG. 3 is an illustration of a prior art tubular device.

FIG. 4 is an illustration of the tubular device of FIG. 3 inserted into a service.

FIG. 5 is an illustration of the situation where encrustation in the service prevents the full insertion of the tubular device of FIG. 3 into a service.

FIG. 6 is an illustration of the situation where encrustation in the service causes the tubular device of FIG. 3 to be inserted at a tilt into a service.

FIG. 7 is an illustration of the situation where encrustation in the service causes a narrower tubular device of FIG. 3 to be inserted at a tilt into a service.

FIG. 8 is a perspective view of a service reinforcement sleeve.

FIG. 9 is a side view of a service reinforcement sleeve.

FIG. 10 is a top view of a service reinforcement sleeve.

FIG. 11 is an illustration of the service reinforcement sleeve inserted into a service with no encrustation.

FIG. 12 is an illustration of the service reinforcement sleeve inserted into a service with encrustation.

FIG. 13A is a side view of a service reinforcement sleeve with embossing.

FIG. 13B is a side view of a service reinforcement sleeve with roughening.

FIG. 14 is an illustration of a conduit with a service and a cork or plug in the service.

FIG. 15 is an illustration of a conduit and service lined with a structural liner where the service has been opened and the cork or plug removed leaving cork or plug debris.

FIG. 16 is an illustration of a conduit and service lined with a structural liner where the service has been opened and the lower part of the service and surrounding liner has been abraded.

FIG. 17 is an illustration of a conduit and service lined with a structural liner where the service has been opened and the lower part of the service and surrounding liner has been abraded, showing a service reinforcement sleeve and an installation tool.

FIG. 18 is an illustration of a conduit and service lined with a structural liner where the service has been opened and the lower part of the service and surrounding liner has been abraded, showing a service reinforcement sleeve and an installation tool inserted into the service.

FIG. 19 is an illustration of a conduit and service lined with a structural liner where the service has been opened and the lower part of the service and surrounding liner has been abraded, showing an inserted service reinforcement sleeve in the presence of encrustation.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. Those of skill in the art understand that other embodiments may be utilized and structural changes may be made without departing from the scope of the present invention. Likewise, a reasonably broad scope for claimed or covered subject matter is intended. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

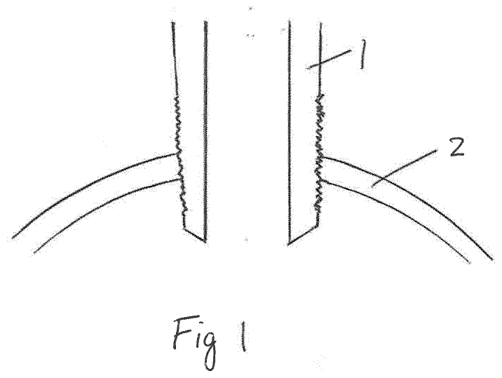

A typical conduit with a service that protrudes into the conduit is illustrated in FIG. 1. Turning to FIG. 1, there is a conduit or host pipe 2 that has a service 4. There is an area 3 of host pipe 2 that is stressed by the presence of service 4.

When rehabilitating conduits using a cured-in-place liner system, a goal is to create a “structural liner”—a liner that has sufficient structural and functional integrity that it will function as a replacement conduit even if the original conduit totally fails. An ongoing concern is dealing with the area around services that attach to the main conduit, which are subject to stress. There is an ongoing need for methods and associated devices to better connect structural liners to services given (a) the possibility that during the lifetime of the structural liner, the original conduit will fail in the area around the service, and (b) the possibility that the area of the original conduit around the service has already failed before the structural liner is emplaced.

The inventors have considered this problem, considering the following factors. First, the conduit, service and structural liner are all rigid. This has several implications, discussed below, and generally brings into question previous solutions that are designed for flexible services or conduits.

Second, the inside surface of the service may be become pitted, with mineral deposits and tubercules, known as encrustation and tuberculation forming in the service. For brevity, these are referred to in this description as encrustation.

Third, tubular devices with flanges inserted into services so that the flange rests against either the inner wall of the conduit or the inner wall of a structural liner often fall out before curing if the devices are inserted into services that have a core roughly perpendicular to the ground.

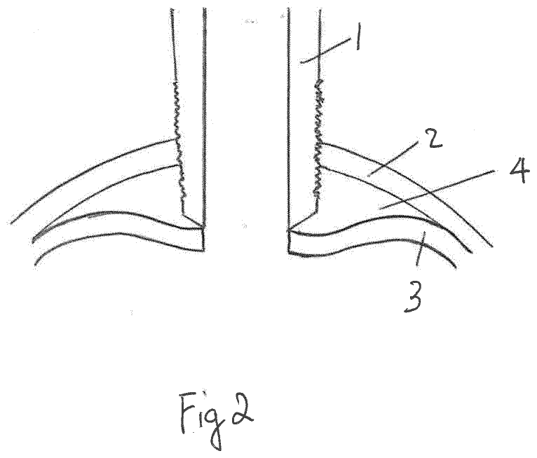

FIG. 1 illustrates this problem. Turning to FIG. 1, there is a host pipe 2 and a service 1. In FIG. 2, a cured-in-place liner 3 is installed, with an epoxy layer 4. In FIG. 2, a hole has been cut into liner 3 exposing the entrance to service 1.

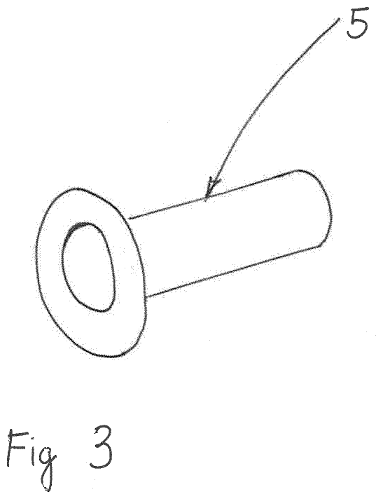

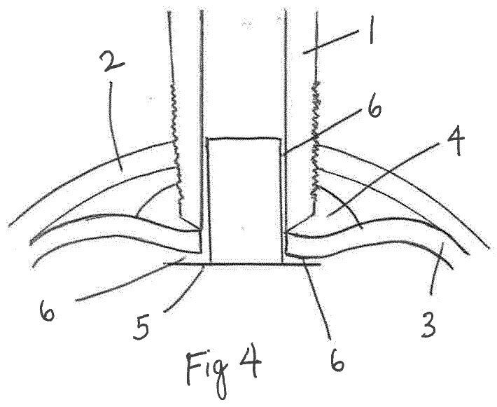

FIG. 3, prior art, shows a simple tubular device with a flange 5. In FIG. 4, device 5 is inserted into service 1. Even if the tubular device 5 is surrounded by epoxy 6, it is likely that the device 5 will fall out of the service before the epoxy 6 can be cured. Since simple device 5 is installed after the installation of the cured-in-place liner, epoxy 6 will typically cure simply through the passage of time, not through the application of heat or a hardening agent. In tests run by the applicant, in ten cases where a device of configuration 5 was inserted into a service 1 with surrounding epoxy, and service 1 was roughly perpendicular to the ground, the device 5 fell out of service 4 within twenty minutes in all cases.

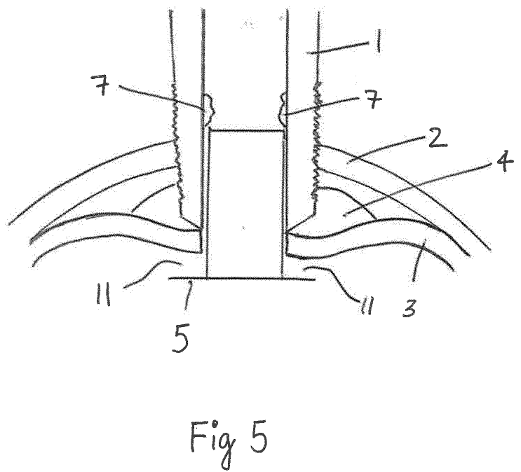

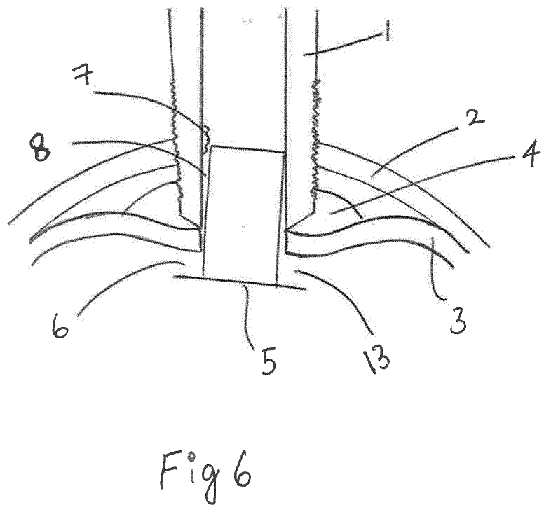

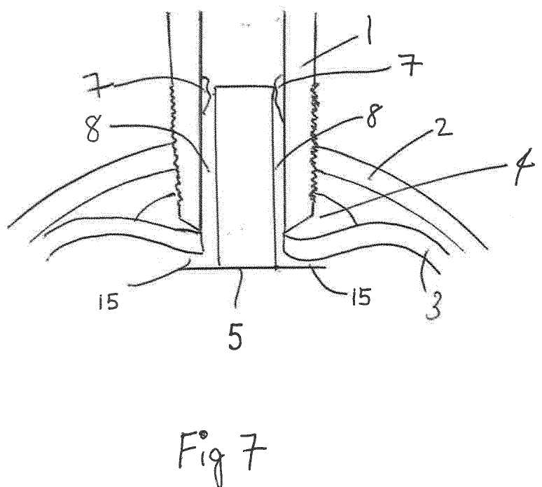

Further complicating such installations is the possibility of encrustation and tuberculation in the inside of the service 1. Conduits and services are commonly rehabilitated after decades of use, and some level of encrustation can be encountered. Recall that the service, conduit and structural liner are all rigid. As seen in FIG. 5, if there is encrustation 7 in the service, it may prevent the full insertion of a simple device 5. This will result in a greater gap 11 between the flange of simple device 5 and liner 3, which increases the possibility of voids in the epoxy in gaps 11, which in turn would weaken the bond between the service 1 and the liner 3. As seen in FIG. 6, even if the simple device 5 is more fully inserted at an angle, the presence of encrustation 7 will tend to increase the gap 8 between the wall of the service 4 and the tubular side of the device 5 and gap 13 between the flange of simple device 5 and liner 3. This is undesirable, as it increases the possibility of voids being present in the epoxy used to fill gap 8 and/or 13, which if present weakens the bond between the service 1 and the structural liner 3. Alternatively, as seen in FIG. 7, a simple device 5 of lesser diameter may be used and fully inserted in service 1, which will narrow gap 15 by allowing the flange of simple device 5 to be pressed against liner 3. However, this approach will increase gap 8 between the tubular portion of the simple device 5 and the inside walls of service 1, again increasing the possibility of a void in the epoxy filling gap 8. In addition, the use of a simple device 5 of lesser diameter would result in a smaller flow area through the combined service 1/simple device 5 compared to a simple device 5 of a greater diameter.

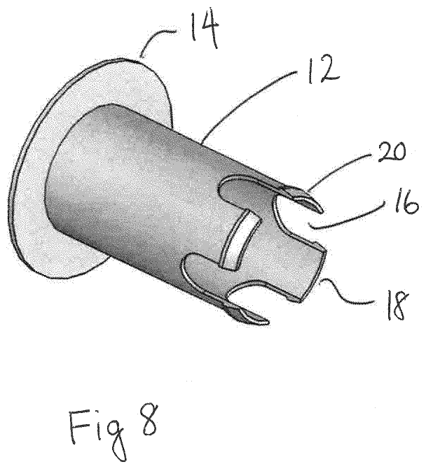

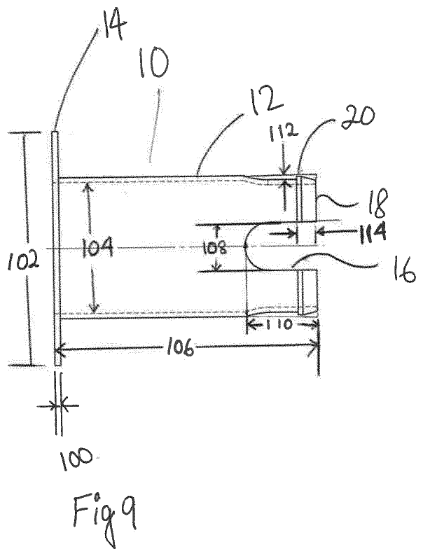

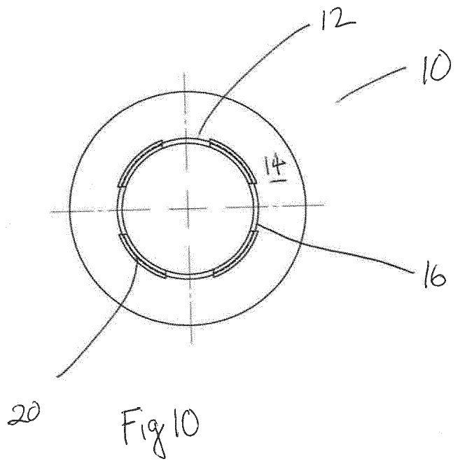

To address these concerns, a service reinforcing sleeve 10 as illustrated in FIG. 8 is used. FIG. 8 is a perspective view of the service reinforcing sleeve 10, FIG. 9 is a side view of the service reinforcing sleeve 10, and FIG. 10 is a top view of service reinforcing sleeve 10. Turning to FIGS. 8, 9 and 10, the service reinforcing sleeve 10 has a tubular body 12 and an annular flange 14 extending generally radially. The tubular body 12 provides a conduit along which fluid may flow. The end of the tubular body 12 opposite flange 14 has four cutouts 16 creating four tabs 18. Each tab 18 has a lip 20. Annular flange 14 is illustrated as an annular ring, but other shapes of flange may be used.

The use of cutouts 16 in a reinforcing sleeve or simple device 5 is disfavoured when connecting two conduits, or a conduit and a service, since the cutouts 16 generally promote the leakage of fluid around the cutout in the absence of epoxy.

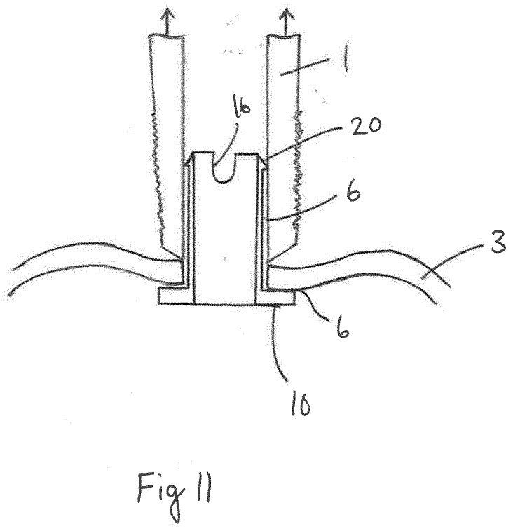

In use, service reinforcing sleeve 10 is inserted into service 1. As seen in FIG. 11, the lip 20 on the service reinforcing sleeve 10 holds the service reinforcing sleeve 10 in place after insertion into the service 1. In practice, this would have to hold at least long enough for the epoxy 6 to be cured. This creates a bond between the service 1 and the liner 3, dependent upon the strength of the epoxy connections 6.

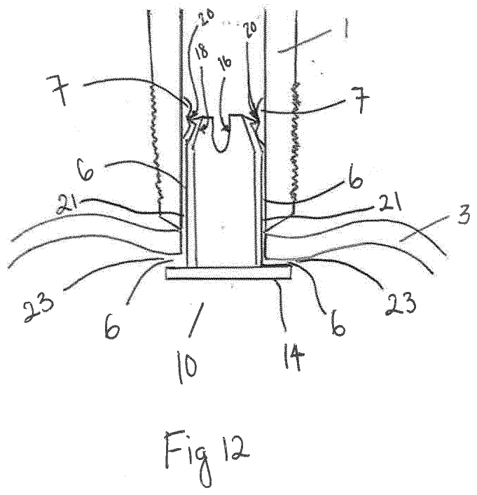

In the case of encrustrations 7, as illustrated in FIG. 12, the tabs 18 will have some give or bend, allowing the service reinforcing sleeve 10 to be inserted while minimizing the space or gap 21 between the side of the annular tube of service reinforcing sleeve 10 and the inner wall of service 1 which is to be filled with epoxy 6. Thus the use of the service reinforcing sleeve 10 when there is encrustation 7 in the service 1 as illustrated in FIG. 12 reduces the gap 21, reducing the possibility of a void in the epoxy 6 in gap 21, while simultaneously allowing the flange 14 of service reinforcing sleeve 10 to be pressed against liner 3, reducing or eliminating the gap 23 between the flange 14 and liner 3. Reducing or eliminating gaps 21 and 23 lessens the possibility of a void in epoxy 6, thus strengthening the bond between the service 1 and the liner 3.

Note that the tabs 18 (defined by cutouts 16) flex independently of each other. This is advantageous, since in practical situations the encrustations 7 may be non-uniform—for example, there may be a significant encrustation on one side of the service while the opposite or adjacent sides are relatively clear. Using tabs 18 allows the service reinforcement sleeve to accommodate significantly non-uniform encrustations, as compared to simple tapering of the tubular body 12.

There are many embodiments of the service reinforcing sleeve 10, as the sleeve 10 should be sized to match the size of the service being reinforced. The dimensions of eight embodiments are listed in Tables 1 and 2. Table 1 gives the dimensions in inches, and Table 2 provides the same dimensions in millmetres. The top row of Tables 1 and 2 gives the nominal size of the service that the particular embodiment of sleeve 10 is designed to work with. A long and a short embodiment of the sleeve 10 is provided for each nominal size of the service, since the service may have been shortened before installation of the sleeve 10 (for example, if the service is damaged, the service may be ground to fix and/or shorten the service). Turning to FIG. 9, in Tables 1 and 2 the flange 14 has a thickness 100 and a diameter 102; the tubular section 12 has a diameter 104, and a length 106. Each cutout 16 has a width 108 and a depth 110 measured from the bottom of the cutout to the end of the tubular section. Each lip 20 has an extension 112 and the lip is located a distance 114 from the end of the tab 18.

TABLE 1
IMPERIAL (inches)

| | Dimension | | | | | | | |
|---|---|---|---|---|---|---|---|---|
| | 0.625 | 0.625 | 0.750 | 0.750 | 0.925 | 0.925 | 1.000 | 1.000 |
| Configuration (inches) | SHORT | LONG | SHORT | LONG | SHORT | LONG | SHORT | LONG |
| 100 - THICKNESS OF FLANGE | 0.031 | 0.031 | 0.031 | 0.031 | 0.031 | 0.031 | 0.031 | 0.031 |
| 102 - DIAMETER OF FLANGE | 1.234 | 1.234 | 1.234 | 1.234 | 1.64 | 1.64 | 1.64 | 1.64 |
| 104 - DIAMETER OF OPENING | 0.555 | 0.555 | 0.688 | 0.688 | 0.848 | 0.848 | 0.917 | 0.917 |
| 106 - TUBE LENGTH | 0.833 | 1.333 | 0.875 | 1.375 | 0.96 | 1.5 | 0.96 | 1.61 |
| 110 - LENGTH OF CUTOUT | 0.355 | 0.375 | 0.375 | 0.39 | 0.39 | 0.39 | 0.39 | 0.39 |
| 108 - WIDTH OF CUTOUT | 0.209 | 0.25 | 0.25 | 0.28 | 0.28 | 0.28 | 0.28 | 0.28 |
| 112 - EXTENSION FROM TUBE | 0.015 | 0.015 | 0.015 | 0.015 | 0.015 | 0.015 | 0.015 | 0.015 |
| 114 - END DISTANCE TO LIP | 0.1 | 0.1 | 0.1 | 0.1 | 0.1 | 0.1 | 0.1 | 0.1 |

TABLE 2
METRIC (millimetres except where otherwise indicated)

| | Dimension | | | | | | | |
|---|---|---|---|---|---|---|---|---|
| | 0.625 | 0.625 | 0.750 | 0.750 | 0.925 | 0.925 | 1.000 | 1.000 |
| Configuration (inches) | SHORT | LONG | SHORT | LONG | SHORT | LONG | SHORT | LONG |
| 100 - THICKNESS OF FLANGE | 0.7874 | 0.7874 | 0.7874 | 0.7874 | 0.7874 | 0.7874 | 0.7874 | 0.7874 |
| 102 - DIAMETER OF FLANGE | 31.3436 | 31.3436 | 31.3436 | 31.3436 | 41.656 | 41.656 | 41.656 | 41.656 |
| 104 - DIAMETER OF OPENING | 14.097 | 14.097 | 17.4752 | 17.4752 | 21.5392 | 21.5392 | 23.2918 | 23.2918 |
| 106 - TUBE LENGTH | 21.1582 | 33.8582 | 22.225 | 34.925 | 24.384 | 38.1 | 24.384 | 40.894 |
| 110 - LENGTH OF CUTOUT | 9.017 | 9.525 | 9.525 | 9.906 | 9.906 | 9.906 | 9.906 | 9.906 |
| 108 - WIDTH OF CUTOUT | 5.3086 | 6.35 | 6.35 | 7.112 | 7.112 | 7.112 | 7.112 | 7.112 |
| 112 - EXTENSION FROM TUBE | 0.381 | 0.381 | 0.381 | 0.381 | 0.381 | 0.381 | 0.381 | 0.381 |
| 114 - END DISTANCE TO LIP | 2.54 | 2.54 | 2.54 | 2.54 | 2.54 | 2.54 | 2.54 | 2.54 |

In all embodiments of Tables 1 and 2, the there are four evenly spaced cutouts 90 degrees apart.

The walls of tubular section 12 are: 0.030 inches (0.762 mm) for the 0.625 inch nominal diameter sleeves; 0.025 inches (0.641 mm) for the 0.750 inch nominal diameter sleeves; 0.031 inches (0.790 mm) for the 0.925 inch nominal diameter sleeves; and 0.034 inches (0.851 mm) for the 1.000 inch nominal diameter sleeves.

In another embodiment, service reinforcing sleeve 10 is made of stainless steel. In a more preferred embodiment, the stainless steel is AISI 316 grade due to its corrosion-resistant properties. However, as a general matter, any material can be used as long as it will provide similar mechanical properties to stainless steel.

The tabs 18 must have some elasticity or flexibility to allow the tabs to bend to accommodate encrustation, but must also be capable of pressing against the inner walls of service 1 to hold service reinforcement sleeve 10 in place in cases where there is no encrustation. The precise measurement of flexibility in a given configuration or size of service reinforcement sleeve 10 depends on (i) the elastic modulus of the material, (ii) the density of the material, and (iii) the coefficient of friction between the material of the inner service wall and the sleeve. For example, for the embodiment of sleeve 10 described above for the 0.75 inch service configuration, the allowable deflection to ensure that the sleeve 10 will remain in the service until curing of the epoxy falls within the range of 0.221 mm to 0.381 mm. (“allowable deflection” means the distance the tab can physically bend from its unloaded state when inserted into a service without encrustation and still apply sufficient friction force to keep the sleeve in the service) The allowable deflection may be calculated for each configuration of the sleeve (corresponding to different service sizes).

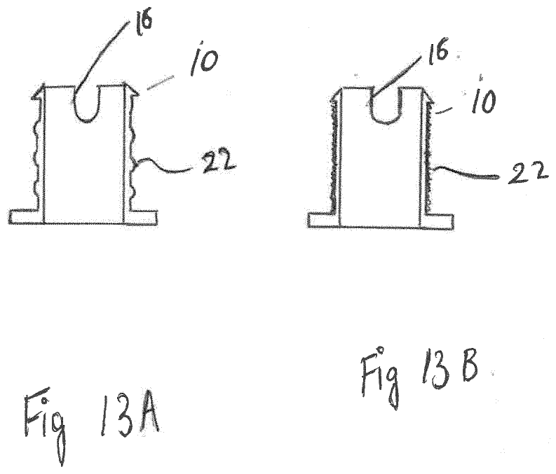

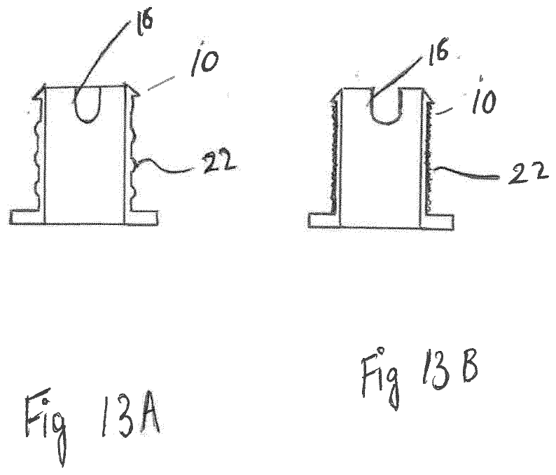

As a further embodiment, the sides 22 of service seal 10 may be embossed, as illustrated in FIG. 13A, or roughened, as illustrated in FIG. 13B. This roughening or embossing will help engage epoxy 6, strengthening the bond between the service 1 and liner 3.

The strength of the bond between the service seal 10 and the service 1 is related to the surface area of side 22 that is bonded with epoxy to the inner wall of service 1. Generally, the longer the tubular body 12 below the cutouts 16 (thus increasing area 22), the stronger the bond with the service 1. As a practical matter, service reinforcement sleeve 10 cannot pass beyond the ball valve in the service, so the length of the service reinforcement sleeve 10 is limited in any real application.

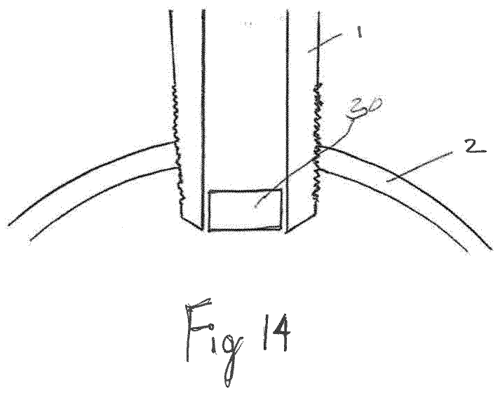

To describe a method of creating a bond between a service 1 and a liner 3 using service reinforcement sleeve 10, we begin with FIG. 14. Turning to FIG. 14, there is a service 1 and a conduit 2. In preparation for the insertion of a structural liner, the bottom of service 1 may be sealed with a plug 30, often a cork, or other blockage to keep epoxy out of service 1 during installation of the structural liner.

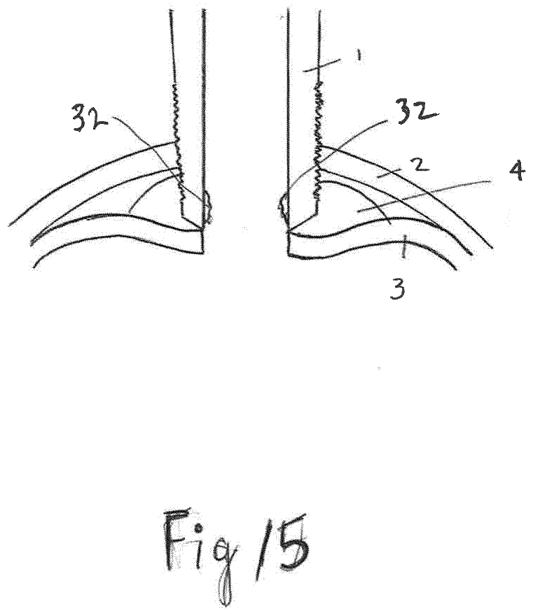

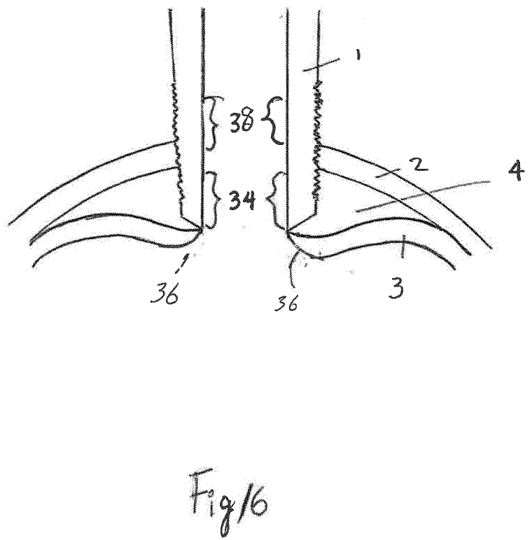

The conduit 2 is then lined with a structural liner, for example by installing a cured-in-place liner. The liner 3 is then cut or otherwise removed to open service 1, and the plug or cork or other blockage 30 is removed. As seen in FIG. 15, once the plug, cork or other blockage 30 is removed, some plug or cork debris 32 will remain at the bottom of service 1. This debris 32 is removed through use of a metal brush (or other appropriate implement), with two results. Turning to FIG. 16, an area 34 has now been micro-abraded, resulting in micro-abrasions that will assist in the bonding with epoxy. In addition the liner 3 has also been abraded creating a seat 36.

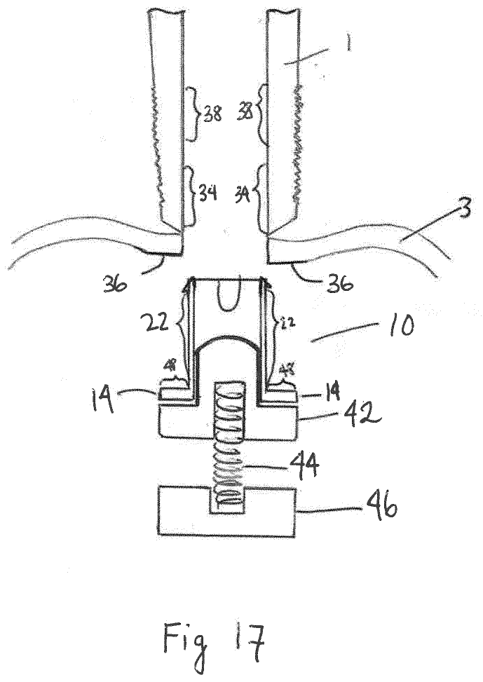

Turning to FIG. 17, an installation tool 40 comprised of an insertion tooling head 42 that is attached to a spring 44 and is held in place by a robot with the tooling base 46. Spring 44 guides the tooling head and service reinforcement sleeve 10 to be oriented in any direction that the service 1 is attached to the liner 3. Service reinforcement sleeve 10 is coated with epoxy on surfaces 22 (of tubular portion 12) and 48 (the upper surface of flange 14).

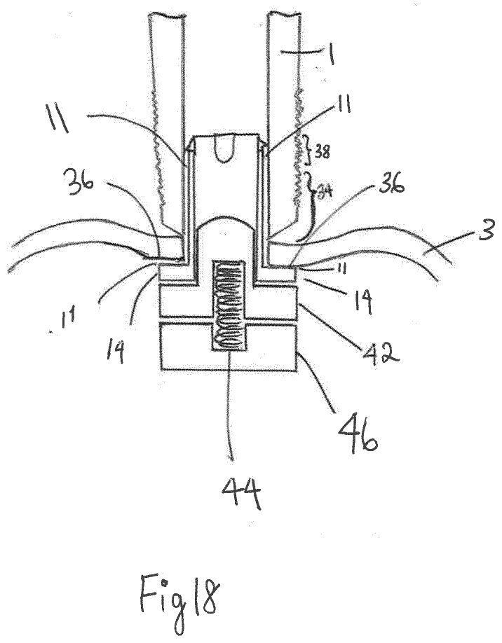

Turning to FIG. 18, tooling head 42 and service reinforcement sleeve 10 have been inserted into service 1. As may be seen in FIG. 18, an advantage of utilizing the metal brush to create seat 36 is that flange 14 of service reinforcement sleeve 10 now fits into seat 36, allowing for flange 14 to be better pressed against liner 3 and create a better bond with epoxy 11. Another advantage of utilizing the metal brush as described above is that it has created area 34 which is micro-abraded, resulting in a stronger bond with the epoxy 11 that is also bonding with area 22 on service reinforcement sleeve 10. Yet another advantage of utilizing the metal brush as described above is that any encrustation in the service 1 should be limited to area 38 (as seen in FIGS. 17 and 18) which as discussed above are accommodated by tabs 18.

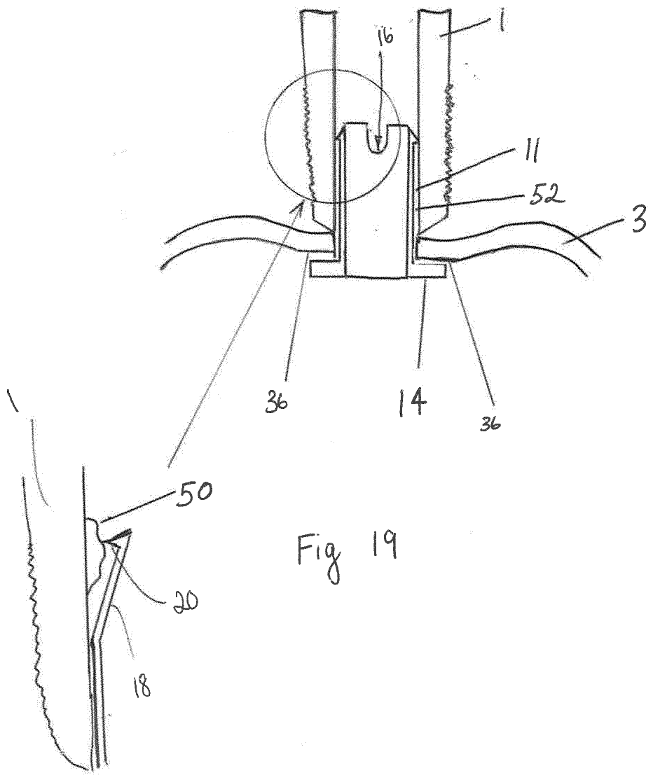

FIG. 19 illustrates the service reinforcement sleeve 10 inserted into a service 1 where there is encrustation 50. Several aspects or advantages of the inventive method and service reinforcement sleeve are illustrated. The use of tabs 18 allows the service reinforcement sleeve 10 to be more fully inserted into service 1 despite the presence of encrustation 50. Tabs 18 and lips 20 also hold the service reinforcement sleeve 10 in place while the epoxy 11 cures. The use of tabs 18 to allow the service reinforcement sleeve 10 to be more fully inserted also means that flange 14 may be more tightly pressed into seat 36 (which was created by the metal brush), making it more likely that a strong epoxy bond is formed between flange 14 and seat 36. The use of tabs 18 also minimizes the gap 52 between tubular portion 12 of service reinforcement sleeve 10 and the inner wall of service 1, allowing for stronger bonding between service reinforcement sleeve 10 and the inner wall of service 1. The use of the metal brush also causes microabrasions at the bottom of service 1 (area 34 in FIGS. 17 and 18), allowing a stronger bond with epoxy 11. Also, the use of the metal brush as described above clears area 34 (as seen in FIGS. 16 and 17) of encrustations, allowing the service reinforcement sleeve 10 to be inserted further into the service 1 before the flexible properties of tabs 18 are needed.

As an optional additional step in the method, in cases where the encrustation makes it difficult to insert service reinforcement sleeve 10, one or more of the tabs 18 may be physically bent towards the central axis of the tubular body 12. To better allow this step, in a preferred embodiment there are four tabs spaced 90 degrees apart, since this makes it easier for an operator orient the bent tabs for insertion around the difficult encrustation. As a generally matter, a service reinforcement sleeve may have three or more tabs, which may of may not be evenly spaced around the circumference of tubular body 12. Two tabs is disfavoured, since such a sleeve would tend to rock or tilt after installation.

Overall, the use of the described method and service reinforcement sleeve 10 result in a greater likelihood of a stronger bond between service 1 and liner 3.

The epoxy used in the method described above and more generally in connection with the use of the service reinforcement sleeve 10 needs to be an epoxy that will cure over a practical time period without the use of heat or another hardening factor. Ideally it should also be viscous enough to facilitate the installation of service reinforcement sleeve 10 without too much loss of epoxy.

It should be noted that service reinforcement sleeve 10 can be used to advantage to connect a liner 3 to a service 1 even if the step of abrading the debris from a cork and creating a seat is not performed. However, in such situations there is a possibility that the service will have encrustations in area 34 (as seen in FIGS. 16 and 17) which may prevent the full insertion of service reinforcement sleeve 10 into service 1, potentially weakening the bond between service 1 and liner 3 via service reinforcement sleeve 10.

The method above describes using a metal brush to abrade away debris 32, create seat 36 and micro-abrade area 34. A person skilled in the art will realize that other methods of abrasion or scouring may be used with the same effect.

The purpose of establishing a strong bond between service 1 and structural liner 3 (via epoxy and service reinforcement sleeve 10) is to render conduit 2 of less importance, to the extent that service 1 and structural liner 3 should continue to robustly function even if conduit 2 completely fails in the area of service 1 or if conduit 2 had failed in the area of service 1 even before the installation of the structural liner. In FIGS. 11, 12, 17, 18 and 19 no conduit 2 is shown, but it should be understood that a conduit 2 could be present without affecting the description associated with the Figure. Similarly, in FIGS. 15 and 16 a conduit 2 is shown, but it should be understood that conduit 2 could be deleted without affecting the description associate with the Figure.

FIGS. 1 through 19 are conceptual illustrations allowing for an explanation of the present invention. Those of skill in the art should understand that various aspects of the embodiments of the present invention could be implemented using different materials, fasteners and minor design modifications. Notably, the figures and examples above are not meant to limit the scope of the present invention to a single embodiment, as other embodiments are possible by way of interchange of some of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention.

In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such.

It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A service reinforcement sleeve for bonding a service to a structural liner comprising:
a tubular body having a first end and a second end opposite the first end, where the tubular body provides a conduit along which fluid may flow;
a flange extending generally radially from the first end of the tubular body;
at least three tabs defined by cutouts at the second end of the tubular body, where each tab has a lip extending generally radially from the end of the tab.

2. The sleeve of claim 1 where the sleeve is made of stainless steel.

3. The sleeve of claim 1 where the sleeve is made of a material with similar mechanical properties to stainless steel.

4. The sleeve of claim 3 where the tabs are sized to enable sufficient binding to occur for the sleeve to remain in a service under the effects of gravity.

5. The sleeve of claim 1 where the flange is an annular ring extending radially from the outer diameter of the first end.

6. The sleeve of claim 5 where the flange has a diameter of 31.3436 mm, a thickness of 0.7874 mm, the conduit formed by the tubular member has a diameter of 14.097 mm the tubular member has a length 21.1582 mm and a wall thickness of 0.762 mm, and there are four tabs defined by cutouts with a width of 5.3086 mm and a length 9.017 mm, and each lip has an extension of 0.381 mm and is located a distance 2.54 mm from the end of the tab.

7. The sleeve of claim 6 where the allowable deflection falls within the range of 0.221 mm to 0.381 mm.

8. The sleeve of claim 7 where the tubular body is embossed or roughened.

9. A method of bonding a service attached to a conduit to a structural liner installed in the conduit, comprising:
Locating the service and inserting a plug into the service;
Installing a structural liner;
Opening the service and removing the plug;
Using an abrading device to abrade the lower part of the service and the surrounding liner;
Preparing a service reinforcement sleeve which comprises:
a tubular body having a first end and a second end opposite the first end, where the tubular body provides a conduit along which fluid may flow; a flange extending generally radially from the first end of the tubular body; and at least two tabs defined by cutouts at the second end of the tubular body, where each tab has a lip extending generally radially from the end of the tab;
and coating the tubular body and the flange with epoxy;
Inserting the service reinforcement sleeve into the service; and
Allowing the epoxy to cure.

10. The method of claim 9 where the plug is a cork.

11. The method of claim 9 where the structural liner is a cured-in-place liner.

12. The method of claim 9 where the step of using an abrading device to abrade the lower part of the service and the surrounding liner creates a seat in the liner around the service; and abrades a portion of the service nearest the structural liner.

13. The method of claim 9 where the step of inserting the service reinforcement sleeve into the service comprises inserting the sleeve so that the flange rests in the seat.

14. A service bonded to a structural liner, comprising:
a service reinforcement sleeve which comprises:
a tubular body having a first end and a second end opposite the first end, where the tubular body provides a conduit along which fluid may flow; a flange extending generally radially from the first end of the tubular body; and at least two tabs defined by cutouts at the second end of the tubular body, where each tab has a lip extending generally radially from the end of the tab;
the service being bonded to the tubular body; and
the liner being bonded to the flange.

15. The service bonded to a structural liner of claim 14, where the service is bonded to the tubular body by epoxy and the liner is bonded to the flange by epoxy.

16. The service bonded to a structural liner of claim 15, where the flange is bonded to a seat that has been abraded into the liner.
